(19) United States
(12) Patent Application Publication
(10) Pub. No.: US 2015/0024888 A1
(43) Pub. Date: Jan. 22, 2015

(54) DISPLACEMENT EQUALIZING HYDRAULIC TENSIONER FOR MULTI-STRAND ENDLESS CHAIN

(71) Applicants: Silas G. Curfman, Sunnyside, WA (US); Robert M. Curfman, Sunnyside, WA (US)

(72) Inventors: Silas G. Curfman, Sunnyside, WA (US); Robert M. Curfman, Sunnyside, WA (US)

(73) Assignee: Robert M. Curfman, Sunnyside, WA (US)

(21) Appl. No.: 14/296,895

(22) Filed: Jun. 5, 2014

Related U.S. Application Data
(60) Provisional application No. 61/847,958, filed on Jul. 18, 2013.

(51) Int. Cl. F16H 7/12

(52) U.S. Cl. CPC F16H 7/12; F16H 2007/0812
USPC 474/110

(57) ABSTRACT

A method and apparatus for tensioning multi-strand endless chain conveyors ensuring equal displacement and constant alignment of each strand of endless chain. Included are a hydraulically actuated cylinder assembly, a equalizing yoke assembly, and a guide frame assembly. Hydraulic lines supplying fluid to the cylinder assembly have both check valves to prevent retraction and pressure sight indicators to signal when proper hydraulic pressure is achieved during adjustment. A common yoke and guide track is included to maintain equal displacement of chain strands while applying tensioning force. Also included is a guidance apparatus that prevents seizing of components due to foreign debris and also allows for easy removal of system for maintenance or replacement.

### REFERENCES

This application claims the benefit of PPA Ser. No. 61/847,958, filed Jul. 18, 2013

### BACKGROUND

The present invention is in the technical field of agriculture machinery. More particularly, the present invention is in the technical field of mobile bulk material handling and transport equipment incorporating multi-strand endless chain conveyors.

Conveyor tensioning devices as found on conventional mobile bulk material transport equipment, such as manure spreaders, compost spreaders, animal feed delivery vehicles, and the like, typically are cumbersome to adjust, difficult to maintain equal displacement of chain strands, and incapable of handling the forces associated with conveyor direction reversal. Adjusting such tensioners requires multiple tools, can only be done with the vehicle(s) out of service, and cannot easily ensure equal displacement of each strand of chain. Due to this it is not uncommon for such chains to fail due to lack of, or improper, maintenance. Further, such tensioners have the limitation that they cannot withstand the high forces encountered if the direction of conveyor operation should need to be reversed.

### RELEVANT PRIOR ART INCLUDES

U.S. Pat. No. 4,457,564—Tensioning device for endless chain

U.S. Pat. No. 6,322,171—Track tensioning assembly

U.S. Pat. No. 5,738,421—Hydraulic chain tensioning means for tensioning the crawler chains of crawler vehicles

U.S. Pat. No. 3,963,047—Fill and relief valve arrangement

U.S. Pat. No. 7,922,266—Chain tensioning device

U.S. Pat. No. 5,984,436—Hydraulic track tensioning circuit

U.S. Pat. No. 6,929,334—Caterpillar track tensioning management

U.S. Pat. No. 7,770,984—Track belt tensioning method

U.S. Pat. No. 4,681,376—Apparatus for tensioning a track chain of a tracklaying vehicle

U.S. Pat. No. 6,249,994—Apparatus and method for operating track tensioning assembly of a hydraulic excavator

### ADVANTAGES

One advantage is that the present invention ensures equal displacement of each strand of multi-strand conveyors rather than equal force. Without ensuring an equal displacement of each strand while tensioning, other mechanisms fail to maintain the alignment and common wear necessary in multi-strand systems. Another advantage is that by incorporating a hydraulic check as a braking mechanism the present invention can withstand high forces encountered during conveyor direction reversal. Finally another advantage is by including manually operated remote application ports with visible pressure indicators operators can maintain proper tension in a manner both safer and more accurate than all other methods.

### BRIEF SUMMARY OF THE INVENTION

The present invention is a hydraulically actuated chain tensioning device for multi-strand endless chain conveyors. The invention is configured to be mounted within a loop of multi-strand endless conveyor chain thus applying tension and alignment from within the loop of chain. The invention includes a single acting hydraulic cylinder which applies pressure to a common yoke and provides a hydraulic braking effect in the case of conveyor direction reversal. The invention includes a common yoke which ensures equal displacement is applied to multiple tension arms. The invention includes a free running non-seizing guide track to ensure constant alignment of common yoke and tension arms, as well as prevent seizing or freezing of tension arms within the guide track. Remote inlet ports are included. These remote inlet ports can be accessed at a safe distance away from the conveyor chain and include sight indicators that signal when proper tension is applied.

### BRIEF DESCRIPTION OF THE DRAWINGS

FIG. 1. FIG. 1 shows a perspective view of the present invention mounted in a possible configuration.

FIG. 2. FIG. 2 illustrates a perspective detail view of the present invention.

FIG. 3. FIG. 3 presents a perspective detail view of the present invention

FIG. 4. FIG. 4 presents an exploded view of the present invention.

FIG. 5. Presents an exploded view of the hydraulic cylinder device of the present invention.

FIG. 6. Presents an exploded view of the common yoke device of the present invention.

FIG. 7. Presents an exploded view of the guide track device of the present invention.

### DRAWINGS—REFERENCE NUMERALS

1—hydraulic actuator assembly
2—equalizing yoke assembly
3—guide frame assembly
4—hydraulic cylinder
5—piston wiper
6—pressure seal
7—piston
8—check valve
9—hydraulic line
10—remote inlet port
11—displacement arm
12—equalizing beam
13—idler axle
14—guide bearing
15—fixed frame
16—removable access pads

### DETAILED DESCRIPTION AND BEST MODE OF IMPLEMENTATION

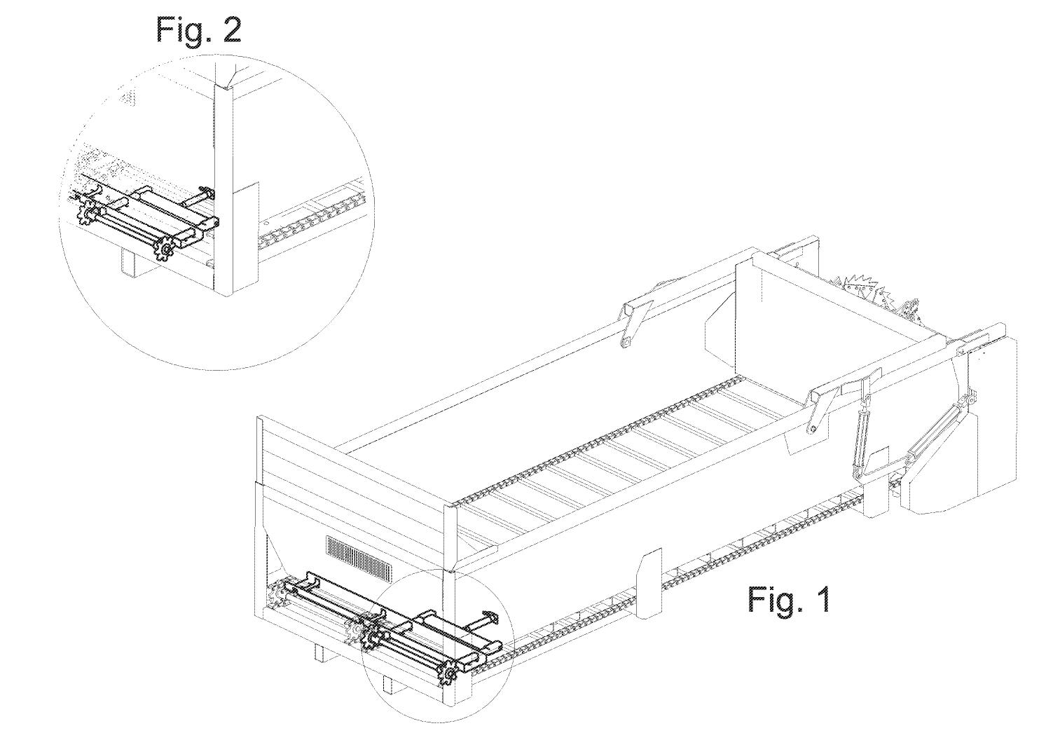

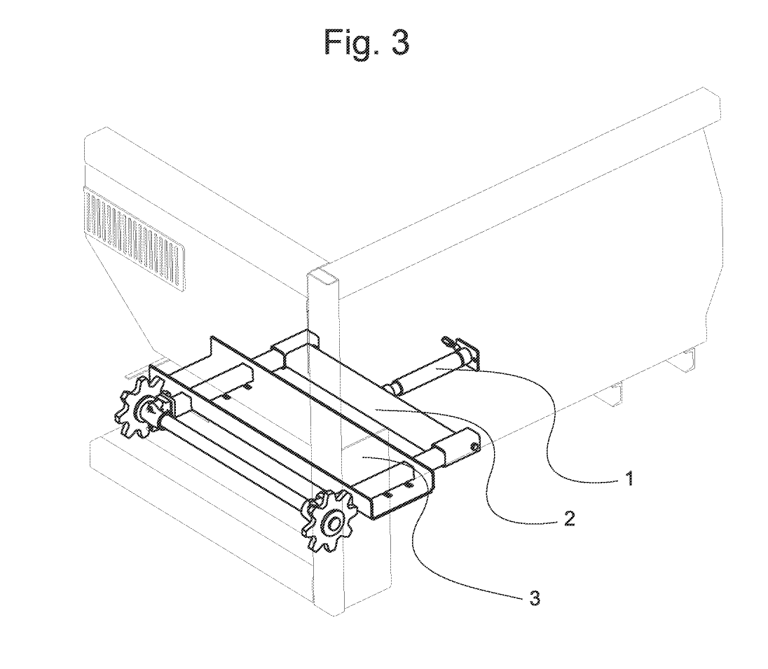

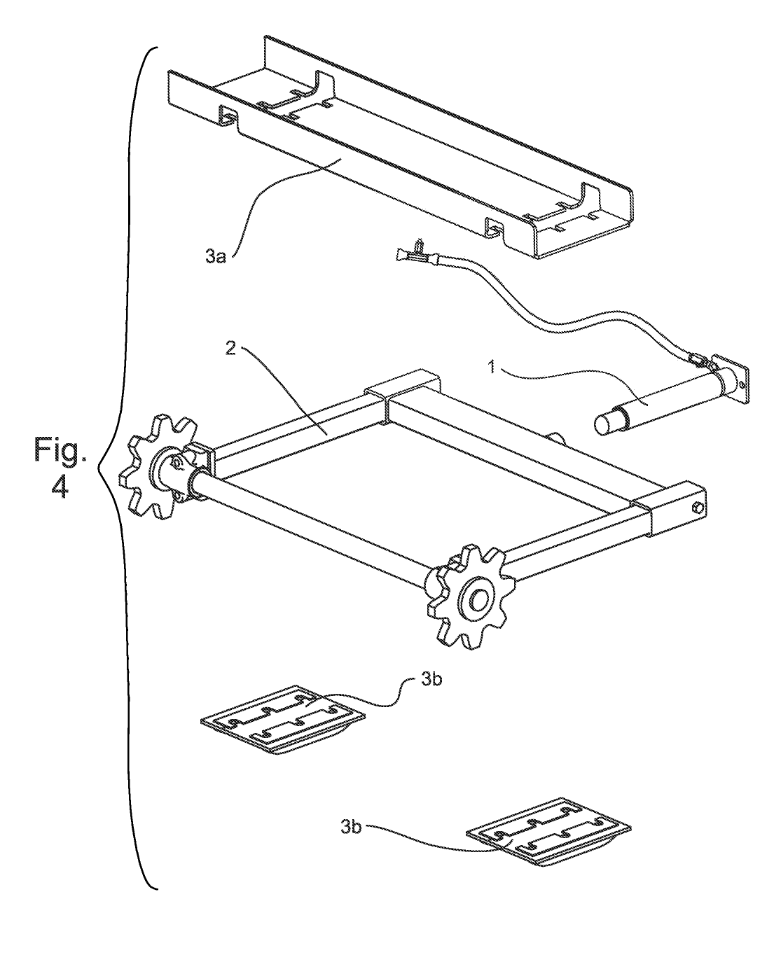

Referring now to the invention in more detail, FIG. 1, FIG. 2, and FIG. 3 there is shown a hydraulic tensioning device being mounted within the loop of an endless chain multi-strand conveyor. Shown is a hydraulic actuator 1 applying force to a equalizing yoke assembly 2 being guided by a guide frame assembly 3 ensuring tension force is applied while maintaining an equal displacement of the displacement arms 11 and idler axle 13.

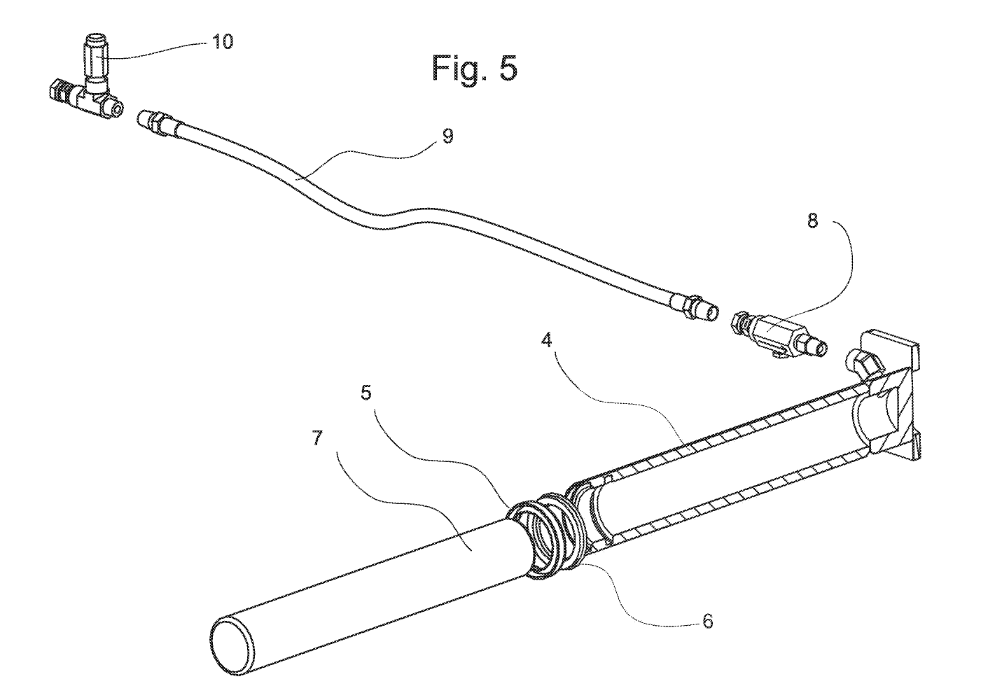

In further detail, referring to FIG. 5, the piston 7 is actuated by the application of hydraulic medium, such as hydraulic oil or grease, at remote inlet port 10 through hydraulic line 9 past check valve 8 having filled hydraulic cylinder 4. Constant pressure is maintained in hydraulic cylinder 4 by the combined operation of pressure seal 6, check valve 8, and remote inlet port 10. Over pressuring of hydraulic cylinder 4 is prevented by remote inlet port 10 relieving hydraulic pressure at a fixed desired input pressure. A braking effect, necessary to withstand conveyor direction reversal, is provided by a one-way check valve 8 having a higher fixed pressure setting than remote inlet port 10.

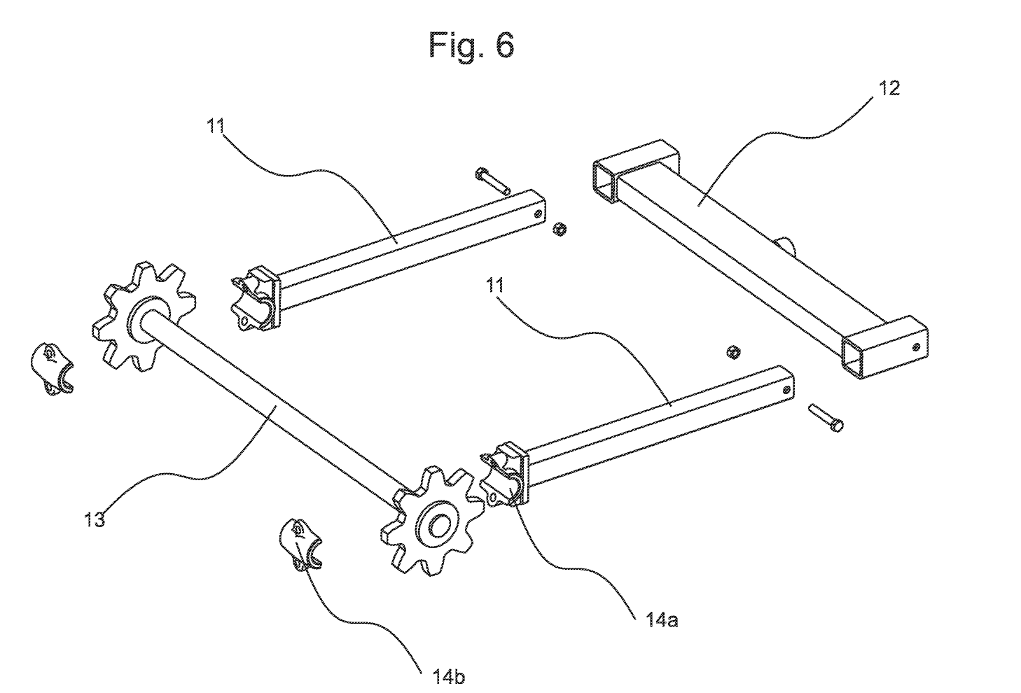

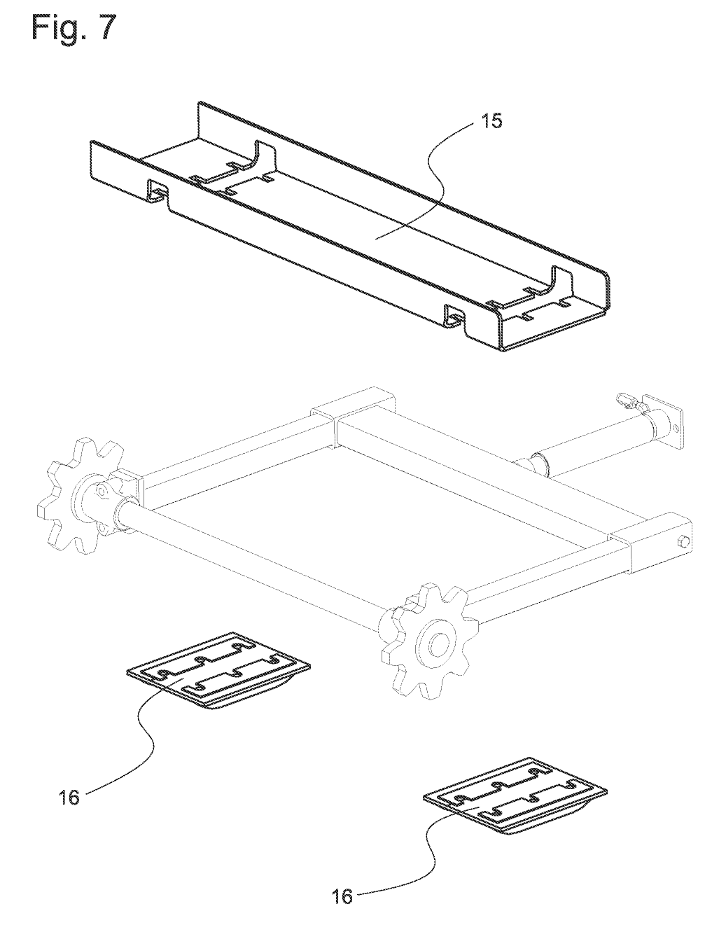

Referring now to FIG. 4, FIG. 5, FIG. 6, and FIG. 7 there is shown a yoke 12 fixed to multiple displacement arms 11 which support an idler axle 13. As piston 7 extends and applies force to equalizing beam 12 advancing displacement arms 11 contained in fixed frame 15 held in position by removable access pads 16. As displacement arms 11 slidably advance in fixed frame 15 misalignment is prevented by the close fit between them. As displacement arms 11 are prevented from misalignment by fixed frame 15 the idler axle 13 applies tensioning force at a uniform displacement to each strand of a multi-strand endless chain.

Referring now to FIG. 6 and FIG. 7 multiple methods for removal and service of hydraulic actuator 1 and equalizing yoke assembly 2 are provided. First, equalizing yoke assembly 2 can be disassembled and displacement arms 11 can be removed through fixed frame 15 in a direction parallel to the operating axis of piston 7. By removing check valve 8 piston 7 can be retracted into hydraulic cylinder 4 thus allowing equalizing beam 12 to be removed in a direction perpendicular to the operating axis of piston 7. Further, an alternate removal exists. By removing removable access pads 16 the entire equalizing yoke assembly 2 and hydraulic actuator 1 can be removed in a direction perpendicular to the operating axis of piston 7.

### CONCLUSION

Accordingly, the reader will see that the displacement equalizing tensioning apparatus can be used to ensure and maintain alignment of all strands of a multi-strand conveyor chain. Furthermore the tensioning apparatus has the additional advantages in that:
a. it permits the withstanding of high forces due to conveyor direction reversal, thus allowing regular and repeated reversals without damaging the conveyor drives;
b. it provides a remote indication of proper tensioning force thus allowing operators to maintain a safe distance away from the tensioning apparatus;
c. it provides an easily accessible access point through track access panels for maintenance and inspection purposes;

I claim:

1. An apparatus for applying equalized tension to a multi strand endless chain, comprising:
a. a guide frame comprising:
i. a fixed frame having a plurality of elongated guide grooves oriented parallel to each other and of equal length,
ii. a removable access pad affixed over each of said guide grooves
iii. said guide grooves and said access pad(s) constitutes a first means for forming an enclosed slide channel and a second means for easily gaining access to interior of said slide channel;
b. an equalizing yoke comprising:
i. an elongated equalizing beam having a plurality of mounts oriented perpendicular to said equalizing beam,
ii. a plurality of displacement arms having mounts at each end and rigidly affixed said equalizing beam and oriented perpendicular to said equalizing beam,
iii. an idler axle, having a plurality of idler sprockets, oriented parallel to said equalizer beam and rotably mounted to said displacement arms opposite said equalizing beam;
c. a hydraulic actuator comprising:
i. a hydraulic cylinder having an extensible piston and a check valve, said hydraulic cylinder being rigidly affixed at one end and contiguous to said equalizing beam at the opposite end and
ii. a hydraulic source connected to said hydraulic cylinder having an inlet port and a relief indicator
iii. whereby hydraulic medium applied through said hydraulic inlet provides a first means for displacement of said hydraulic cylinder thereby causing said displacement arms to travel in a slidably constrained common direction of equal displacement and a provides a second means for said idler axle to retain its position against the urging of the chains contiguous to it.
